(19) United States
(12) Patent Application Publication
(10) Pub. No.: US 2026/0305673 A1
(43) Pub. Date: Oct. 8, 2026

(54) ASSEMBLY FOR PROCESSING FRUIT AND VEGETABLE PRODUCTS

(71) Applicant: UNITEC S.P.A., Lugo (IT)

(72) Inventor: Luca BENEDETTI, Ravenna, Frazione Savarna (IT)

(21) Appl. No.: 19/484,446

(22) PCT Filed: May 16, 2024
(86) PCT No.: PCT/EP2024/063610

§ 371 Date: Nov. 14, 2025

(30) Foreign Application Priority Data
May 18, 2023 (IT) 102023000010014

(51) Int. Cl. A23N 12/02

(52) U.S. Cl. CPC A23N 12/023

(57) ABSTRACT

An assembly for processing fruit and vegetable products, which includes at least two elongated elements for support, arranged mutually side by side and separated by a gap, so as to define a lane for the advancement of fruit and vegetable products, which can move along the lane while resting on the elements above the gap; and a dispensing component for at least one liquid, configured to form at least one first cascade flow of the liquid directed toward a predefined segment of the lane for intercepting the fruit and vegetable the products and any debris in transit.

### CROSS-REFERENCE TO RELATED APPLICATIONS

This application is a 35 U.S.C. § 371 National Stage patent application of PCT/EP 2024/063610, filed on 16 May 2024, which claims the benefit of Italian patent application 102023000010014, filed on 18 May 2023, the disclosures of which are incorporated herein by reference in their entirety.

### TECHNICAL FIELD

The present disclosure relates to an assembly for processing fruit and vegetable products, and method thereof.

### BACKGROUND

As is known, in the sector of packaging and distribution of fruit and of fruit and vegetable products in general, the use is now widespread of plants or lines that are at least partially automated, which are designed and dimensioned to perform a plurality of operations and treatments on a specific type of fruit and vegetable product.

Automation makes it possible to handle in a short timescale and at low cost the great quantities of product that are necessary to meet market demand, while meeting the increasingly high standards of quality imposed by institutions and consumers.

Such systems are therefore capable of subjecting the products to various treatments, among which one treatment of primary importance is certainly that of calibration, a term meaning the selection of the fruit and vegetable products as a function of their dimensions and/or further parameters of interest.

Stations (called “calibration” stations) are therefore arranged along the processing line, and these are capable of automatically verify the parameter of interest for each one of the products in transit, in order to route it to a chosen one of a plurality of different stations downstream (which are thus fed with products that are mutually homogeneous) and/or, for example, to pack them in different packaging materials as a function of the size range.

Precisely because of the importance of this function and because of the heterogeneity of the products that are processed (often arriving directly from the fields where they are harvested), the use is likewise known of a station (called a “pre-calibration” station) which is located upstream of the calibration station explained above and which performs a form of preliminary selection of the fruit and vegetable products.

In more detail, and with reference for example to lines for processing cherries, the pre-calibration station has a plurality of rollers arranged side by side: the cherries are conveyed in the lanes defined between pairs of adjacent rollers, along which they move while in contact with these rollers, remaining suspended above the gaps that separate the rollers from each other. In this manner, during their travel, cherries that are smaller than the transverse dimension of the gap can fall below, and so they do not proceed downstream to the station that is designed to handle only larger cherries.

Simultaneously, the gap allows the fall in part of small stones, leaves, twigs, soil and other debris that may have been fed into the line together with the fruit and vegetable products.

Such implementation solution is not however devoid of drawbacks.

It has been noted in fact that pre-calibration stations with such a configuration are at least partially ineffective in the removal of debris, in that often such debris does not fall through the gaps as intended, and instead accompanies the products along their entire travel and into the stations downstream: failure to remove the debris obviously represents a problem of no small importance, as it is a potential cause of malfunctions or even of stoppages or breakdowns.

This happens, for example, because lighter debris, and/or debris with a major dimension that is larger than the width of the gap, finds a purchase or encounters an obstruction in the products and/or on the rollers which is sufficient to prevent its fall, while the products carry them rapidly downstream.

NL1031590C2 discloses a sorting machine for bulbs and/or tubers wherein running water is used to transport the crops over and through a screen. The sorting machine includes a screen and a device which uses running water to transport the crops over and/or through the screen in the direction of the discharge device on the underside of the screen.

U.S. Pat. No. 1,848,309A discloses a apparatus for treating fruit comprising a mechanism for applying liquid treating material to fruit and rubbing the fruit therewith.

### SUMMARY

The aim of the present disclosure is to solve the above-mentioned problems by providing an assembly for processing fruit and vegetable products that ensures an optimal removal of debris.

Within this aim, the disclosure provides a method of processing fruit and vegetable products that ensures an optimal removal of debris.

Another feature of the disclosure is to effectively remove any debris present among the mass of advancing products.

Another feature of the disclosure is to execute an optimal removal of the debris without penalizing the pre-calibration of the products and without damaging the products.

Another feature of the disclosure is to provide an assembly and a method that ensure a high reliability of operation.

Another feature of the disclosure is to provide an assembly that adopts an alternative technical and structural architecture to those of conventional assemblies.

Another feature of the disclosure is to provide an assembly that can be easily implemented using elements and materials that are readily available on the market.

Another feature of the disclosure is to provide an assembly and a method that are of low cost and safely applied.

This aim and these and other features which will become better apparent hereinafter are achieved by providing an assembly and a method according to the claims.

### BRIEF DESCRIPTION OF THE DRAWINGS

Further characteristics and advantages of the disclosure will become better apparent from the description of some preferred, but not exclusive, embodiments of the assembly and of the method according to the disclosure, illustrated by way of non-limiting example in the accompanying drawings wherein:

FIG. 1 is a side view of the assembly according to the disclosure, in a first embodiment;

FIG. 2 is a greatly magnified side view showing the products while they move along a lane of the assembly of FIG. 1, from which the axially symmetrical elements of the first lanes have been removed in order to better show the fruit and vegetable products;

FIG. 3 is a view from above of the assembly in FIG. 1;

FIG. 4 is a greatly enlarged detail of FIG. 3;

FIG. 5 is a side view of the assembly according to the disclosure, in a second embodiment;

FIG. 6 is a view from above of the assembly in FIG. 5; and

FIG. 7 is a block diagram of the method according to the disclosure.

### DETAILED DESCRIPTION OF THE DRAWINGS

With reference to the figures, the reference numeral 1 generally designates an assembly for processing fruit and vegetable products A.

The fruit and vegetable products A can be of any type (fruit, greens, vegetables, etc.): the accompanying figures show products A constituted by cherries, but this is a purely illustrative choice which corresponds to an application of significant practical interest, but which is not limiting of the scope of protection claimed herein.

Furthermore, although typically (not necessarily) at each work cycle the assembly 1 is fed with a single type of product A, the possibility exists of using the same assembly 1 for different products A in different work cycles (or in the same work cycle), while remaining within the scope of protection claimed herein.

The assembly 1 can be implemented at any point of a processing line for fruit and vegetable products A (of any type), where there is the need to perform a (preliminary) selection/calibration of these products, according to the criteria and objects that will be explained below.

Typically however, the assembly 1 performs a preliminary selection (or “pre-calibration”) of the products A, allowing only those with dimensions greater than a predefined threshold to continue downstream and removing the others; at the same time, the assembly 1 performs (as will be seen, in a particularly effective manner) the removal of any debris present in the mass of products A processed. In this context, preferably (but not necessarily) stations are located downstream of the assembly 1 which are capable of performing a more accurate selection (or calibration), in order to separate the products A mechanically and/or using electronic stations based on vision/data acquisition.

Therefore the assembly 1 comprises, first of all, at least two elongated support elements 2, which are arranged side-by-side and are separated by a (long and narrow) gap 3; the major dimension of the elements 2 (the longitudinal axis) defines a main direction along which the gap 3 obviously also extends, the width of which, if measured with respect to such longitudinal direction, can be fixed or variable.

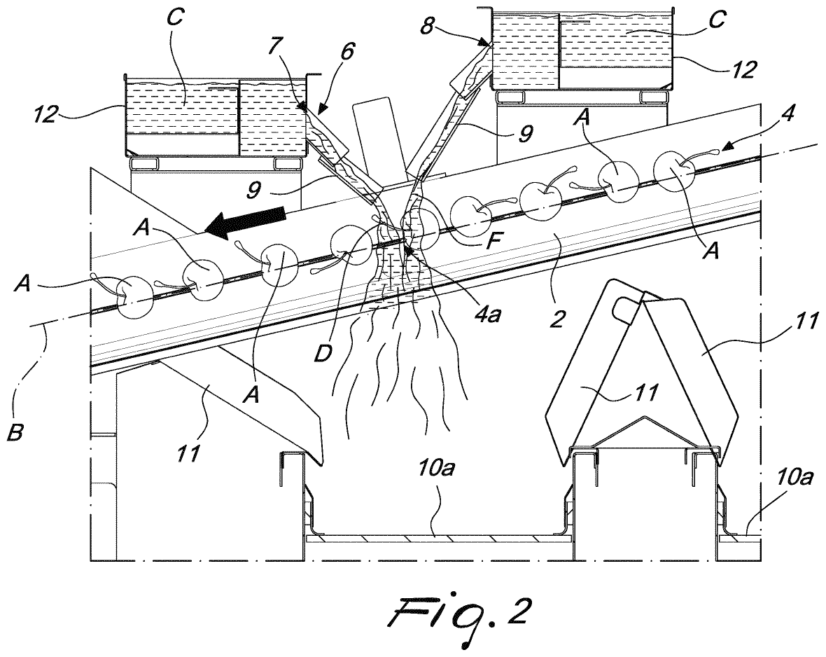

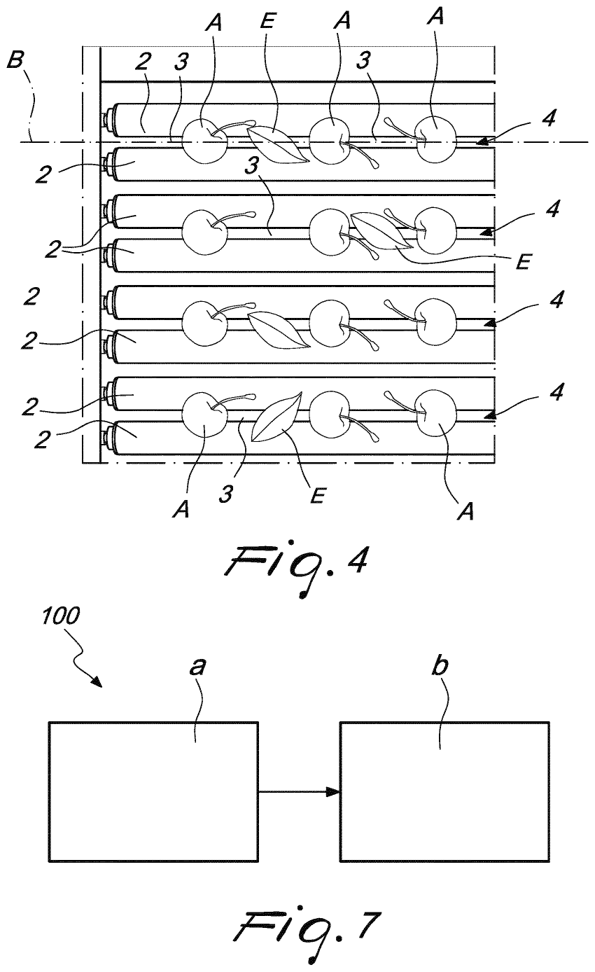

Thus, the elements 2 and the gap 3 define a lane 4 along which the fruit and vegetable products A can be made to advance, and these products A can move along the lane 4, in contact with the elements 2 (while these are kept suspended), above the gap 3. In FIG. 2 and in the enlargement of FIG. 4, the letter “B” therefore indicates the advancement direction of the products A along the lane 4, corresponding to the main, longitudinal, direction of the gap 3 and of the elements 2.

In the present discussion the terms “upstream” and “downstream” are therefore used (in accordance with common practice) precisely with reference to the direction of advancement and to the orientation of advancement imposed on the products A along the lane 4.

The elements 2 (and the lane 4) can substantially lie on a horizontal plane, or (preferably) it is possible for them to be inclined (even more preferably downstream), as in the accompanying drawings, so that the advancement of the products A can be obtained (at least partially) by virtue of gravity. However, the possibility is not ruled out of actively pushing the products A downstream in any other manner, according to requirements or to the state of the art.

According to methods that are per se known, it is envisaged therefore to progressively place the products A in a first section of the lane 4 (typically, proximate to one of the ends of the elements 2) and then to cause their advancement along the lane 4: the products A with dimensions larger than the gap 3 can proceed toward a discharge section of the lane 4 (typically, beyond the other end of the elements 2), while smaller products fall below the lane 4, through the gap 3, where they can be handled separately (for example in the manners that will be explained below). Debris can also fall through the gap 3.

In the embodiment illustrated in the accompanying figures, the elements 2 are constituted by rollers that are substantially cylindrical or in any case axially symmetrical, which are supported at the ends by a supporting frame 5, and the products A slide or in any case advance along the upper portion of these rollers. In order to facilitate the slide downstream (and the fall of the debris), the rollers (or in any case the elements 2) can be rotated about their longitudinal axis.

In any case this is a possible embodiment, which does not limit the application of the disclosure.

According to the disclosure, the assembly 1 comprises dispensing means 6 for at least one liquid C; in particular, typically the liquid C is water, but the possibility is not ruled out of using any other liquid C, while remaining within the scope of protection claimed herein.

The means 6 are configured (dimensioned, arranged and organized) so as to form a first cascade flow D of the liquid C, directed toward a predefined segment 4a of the lane 4 (or even toward the entire lane 4), so as to intercept the products A and any debris in transit. The products A (and any debris) intercepted are those already in transit along the predefined segment 4a (as has been seen, by gravity or because they are pushed in some other manner). Thus, while products A of greater dimensions than those of the gap 3 can still continue on their way downstream, the debris can be removed because it is carried through the gap 3 by the first cascade flow D and forced to fall below the lane 4, thus guarding against the danger that it might continue to travel together with the products A.

This effectively achieves the set aim, in that the action of the first cascade flow D makes it possible to remove cumbersome debris from the lane 4 or debris that, by its nature or arrangement, otherwise might not fall solely by gravity into the gap 3. For example, a leaf E (like the leaves shown for example in FIG. 4) that should somehow manage to remain on the rollers (or on the products A), once it has reached the predefined segment 4a is effectively intercepted and carried under the rollers by the first cascade flow D, which thus prevents the leaf E from continuing toward the stations downstream together with the products A (as could conversely happen with known solutions).

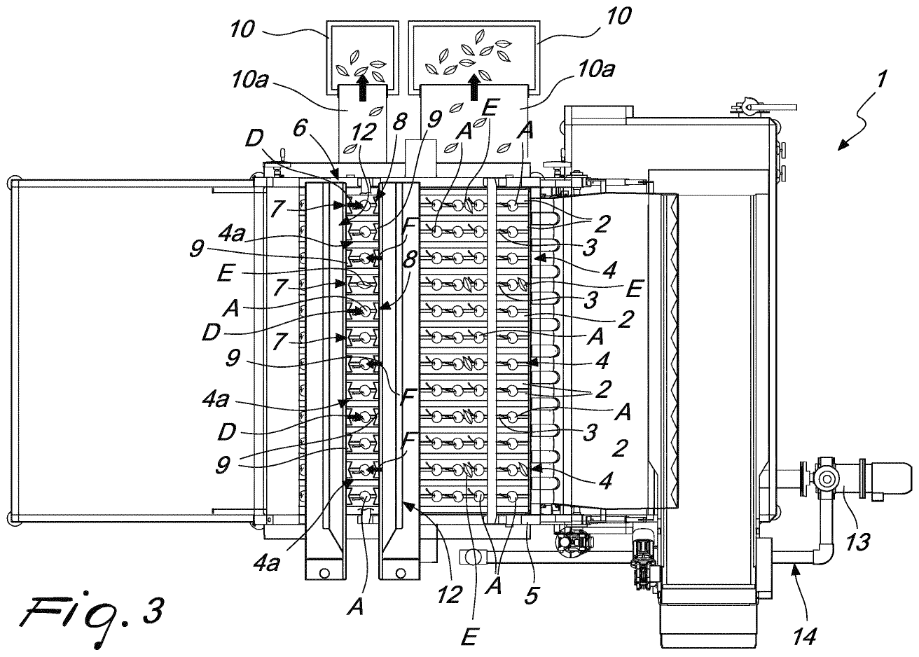

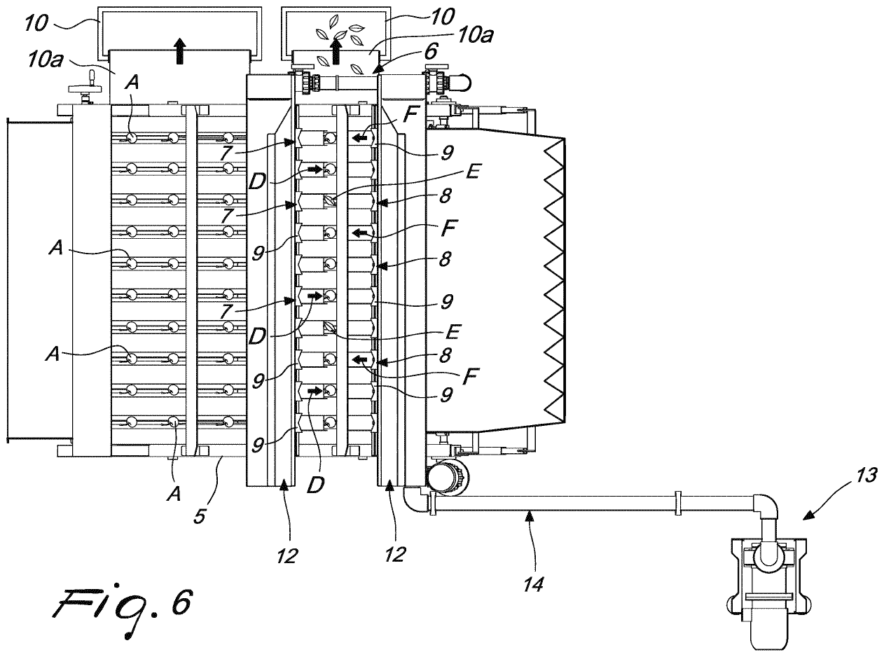

FIG. 2 shows a possible first cascade flow D and FIGS. 3 and 6 the directions of the corresponding flow of liquid C (as well as the orientation) are also indicated by arrows.

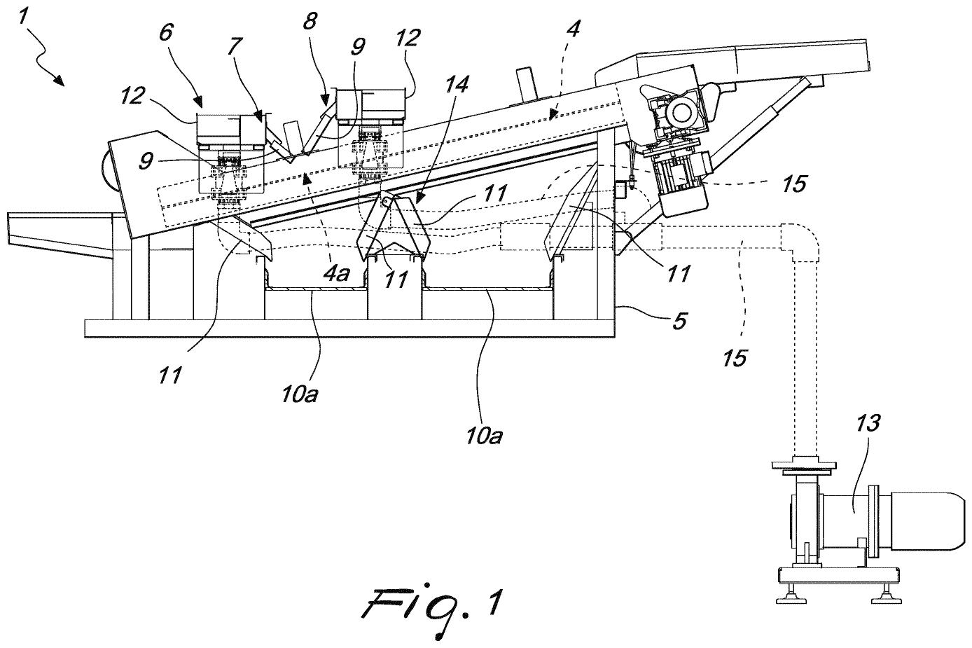

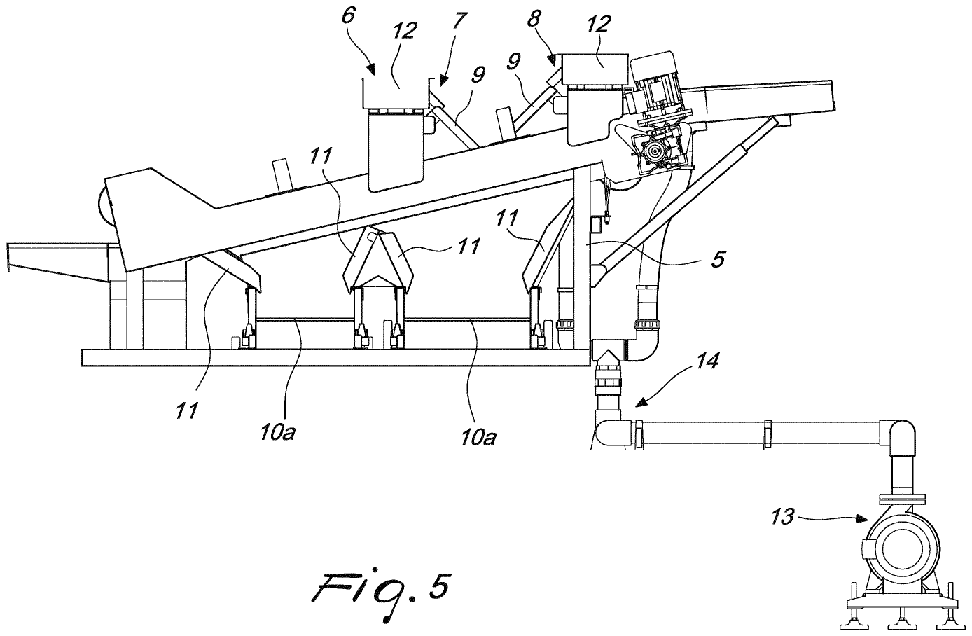

The predefined segment 4a can be chosen at will along the lane 4, according to the specific requirements, and can be of any length (it may even coincide with the entire lane 4). The accompanying figures show two different embodiments of the assembly 1 which differ in precisely this aspect: in the first (FIGS. 1-4) the predefined segment 4a is located downstream; while in the second (FIGS. 5-6), the predefined segment 4a is located upstream.

According to the disclosure, the means 6 comprise at least one first discharge opening 7 (directed toward the predefined segment 4a), which substantially surmounts the elements 2 and which is configured to dispense the liquid C to form the first cascade flow D. In other words, the placement, arrangement and shape of the first opening 7 is such as to obtain the formation of the first cascade flow D.

Typically (but not necessarily), the flow of the liquid C in the first cascade flow D is oriented along the advancement direction B of the products A, imposed by the lane 4. In other words, as in the accompanying figures, the first opening 7 can be arranged right above the lane 4, directed downstream or (as in the accompanying figures) upstream, so that (as can be seen from FIGS. 3 and 6) the flow of liquid C is aligned with the advancement direction B and with the lane 4 (or simply vertical).

The choice to orient the flow of liquid C (and the first cascade flow D) in this manner avoids subjecting the products A (which in any case are struck by the first cascade flow D) to crosswise stresses that could result in knocks (and therefore damage) to the elements 2 (or even their egress from the lane 4).

In particular, the means 6 are configured to form the first cascade flow D and also a second cascade flow F of liquid C, which is directed toward the same lane 4, to further intercept the products A (already in motion along the lane 4) and any debris in transit. More specifically, the means 6 can preferably comprise at least one second discharge opening 8, which also substantially surmounts the elements 2 and is configured to dispense the liquid C with formation of the second cascade flow F.

In this manner, any debris present among the products A advancing along the lane 4 are subjected to the action of no fewer than two cascade flows D, F, further reducing the risk of their continuing downstream without falling below.

The second cascade flow F can be directed substantially toward the same predefined segment 4a or even upstream or downstream of the latter, while remaining within the scope of protection claimed herein.

Furthermore, it should be made clear that the second cascade flow F can be formed using the same liquid C as the first (for example water) or with a different liquid, handled and circulated separately from the other cascade flow. However, in addition to the openings 7, 8, the possibility is not ruled out of having other openings along the same lane 4, in order to obtain an even more marked effect of removal of the debris.

The flow of the liquid C in the second cascade flow F is also preferably (but not necessarily) oriented along the advancement direction B of the products A, imposed by the lane 4.

In a similar manner to that for the first cascade flow, the accompanying FIG. 2 shows a possible second cascade flow F and, in the accompanying FIGS. 3 and 6, arrows indicate the directions of the corresponding flow of liquid C (as well as the orientation).

More specifically, it is possible for the means 6 to be configured to form a first cascade flow D and a second cascade flow F which are oriented along the advancement direction B of the products A, imposed by the lane 4, and preferably in opposite directions (as can clearly be seen from the accompanying FIGS. 3 and 6). In other words, in the cascade flows D, F the flow of liquid C is in any case oriented with the lane 4, but in one case it is directed upstream (for the first cascade flow D, in FIG. 2) and in the other case it is directed downstream (the second cascade flow F, in FIG. 2). This “push-pull” arrangement of the two flows of liquid C makes it possible to ensure greater effectiveness in the action of removing debris, in that the stresses to which the debris is subjected are mutually different and the probability is therefore higher that at least one of them will cause the desired fall. However, the possibility is not ruled out of having the two cascade flows D, F oriented in the same direction.

Usefully, in order to better direct the liquid C and better shape the corresponding cascade D, F, at least one discharge opening 7, 8 (and preferably each one) comprises an associated chute 9 directed toward the lane 4 (the predefined segment 4a or in any case the designated area). The chute 9 can comprise one or more plates of rigid sheet material which are conveniently contoured so as to define a form of discharge channel with a U-shaped or V-shaped transverse cross-section.

In the preferred embodiment, which makes it possible to appreciably increase the hourly productivity of the assembly 1 (at least in terms of the number of products A processed per unit of time), the assembly 1 comprises a plurality of elongated elements 2 (which can be rollers or the like), mutually side by side and separated by respective gaps 3, so as to define corresponding lanes 4, substantially parallel, for the advancement of fruit and vegetable products A. This solution is shown in the accompanying figures, for the purposes of non-limiting example of the disclosure.

In such case, the means 6 are configured to form at least respective first cascade flows D (and optionally second cascade flows F) of the liquid C, which are directed toward corresponding predefined segments 4a of each lane 4. In more detail, the means 6 can comprise at least one respective first discharge opening 7 (and optionally a corresponding second opening 8) for each lane 4 (or for any number at will thereof).

What is said above (or below) in relation to a lane 4 (and/or to an opening 7, 8) must be understood as being extended to any number thereof.

Usefully, the assembly 1 can comprise at least one collection container 10 (which can be a conventional container and for this reason is shown only schematically in FIGS. 3 and 6), which is configured to progressively accumulate leaves E and other debris intercepted by the first cascade flow D and removed from the lane 4. Evidently the smaller products A, which have also fallen through the gap 3, can optionally also be collected in the container 10.

Furthermore, in order to facilitate the collection (in particular, as a function of the chosen placement of the container 10), the assembly 1 can optionally comprise at least one conveyor belt 10a, which is arranged below the predefined segment 4a and which leads to the container 10.

So for example, one or more containers 10 can simply be placed under the predefined segment 4a and/or the gap 3, so that they can directly receive the products A and the removed debris, which fall from the lane 4 above.

Or, as in FIGS. 3 and 6, the (or each) container 10 can be placed beside the elongated elements 2 and the frame 5, with a belt 10a (arranged transversely with respect to the advancement direction B) to receive the products A and the removed debris and convey them to the container 10.

The possibility is not ruled out of using further placements of the container(s) 10 and/or of the belt(s) 10a, according to the specific requirements; there is also no limit to the number of containers 10 and/or of belts 10 that can be fed by each lane 4.

In order to facilitate the collection, the assembly 1 can preferably also comprise one or more containment dividers 11, located below the predefined segment 4a and directed toward the container 10 or the belt 10a.

According to the disclosure, the means 6 comprise at least one tub 12, which can be fed (continuously) with the liquid C and which is located above the lane(s) 4.

The tub 12 has at least one first discharge opening 7. The same tub 12 can also optionally have at least one second discharge opening 8, although preferably the second opening 8 is provided in an additional tub 12.

More specifically, and with specific reference to the preferred, but not exclusive, embodiment in the accompanying figures, in which the assembly 1 has a plurality of lanes 4, the tub 12 comprises at least one plurality of first openings 7, which are substantially aligned along a first direction which is transverse (preferably at right angles) to the lanes 4 (and to the advancement direction B) and which surmount respective predefined segments 4a of corresponding lanes 4.

Furthermore, the same tub 12 can optionally also comprise a plurality of second openings 8, which are substantially aligned along a second direction which is transverse (preferably at right angles) to the lanes 4 (and to the advancement direction B). Preferably however, as in the accompanying figures, the second openings 8 are provided on an additional tub 12, constructed similarly to the first and conveniently placed upstream or downstream of the latter.

The ways in which the means 6 circulate and dispense the liquid C may be any, according to the specific requirements, while remaining within the scope of protection claimed herein.

In particular, it is possible for the means 6 to comprise at least one pump 13 connected to a circuit 14, which can be passed through by the liquid C (driven by the pump 13). In more detail, the circuit 14 (optionally supported along with the pump 13 by the frame 5) can for example comprise tubing 15 which feeds into respective tubs 12, in order to supply them adequately with the liquid C. Moreover, to effectively keep down consumption, the circuit 14 can be capable of ensuring an at least partial recirculation of the liquid C used: in this regard, it is possible to collect the liquid C dispensed in the form of a cascade flow D, F under the lanes 4, to (preferably) filter it and then to reroute it back to the tubs 12 or in any case to the openings 7, 8.

In addition to the assembly 1 according to the disclosure, the present discussion and the protection claimed with it also relate to a method 100 for processing fruit and vegetable products A, which can be performed by means of an assembly 1 according to the foregoing description.

According to the disclosure, the method 100 entails, in a step a., moving, along an advancement lane 4, a plurality of fruit and vegetable products A, which are arranged so as to rest on two elongated elements 2 arranged side by side and above a gap 3 for separating said two elongated elements 2.

Furthermore, the method 100 entails, in a step b., intercepting the products A (and any debris present) with at least one first cascade flow D of liquid C, at the point of their transit through a predefined segment 4a of the lane 4.

The operation of the assembly 1 can easily be deduced from the foregoing description, and a brief summary is given below.

By means of various methods, the assembly 1 is fed indiscriminately with the products A (be they cherries or anything else), which travel along the lanes 4 and are kept suspended above the gaps 3. Along the path (and typically right at the initial part of the lanes 4), the smaller products A (smaller than the transverse dimension of the gap 3) fall below, accumulating in the collection containers 10 (optionally with the aid of belts 10a). So the assembly 1 can perform, for example, a form of pre-calibration of the products A, while the products A that have not fallen, once they have traveled the designated path along the lanes 4, are sent to stations downstream, where for example the actual calibration can be done. It should be noted in any case that the use of the assembly 1 for the pre-calibration of the products A in the sense just described represents a preferred, but non exclusive, application; the possibility is not ruled out of using the assembly 1 in different contexts, while remaining within the scope of protection claimed herein.

The products A with which the assembly 1 is fed typically arrive from fields, or at any rate they have not undergone any particular preliminary checks and they are therefore intermingled with leaves E and debris of various types. Some of this debris (owing to its dimensions or because of how it is positioned in the lanes 4, evidently at random) might not fall into the gaps 3 on its own (something that occurs frequently in conventional solutions) and therefore, in an entirely peculiar and innovative manner, each lane 4 is intercepted by at least one first cascade flow D, which ensures the fall (through the respective gap 3) of those leaves E (or other debris) that might not have fallen on its own.

The removal effect can be boosted by using a second cascade flow F, arranged along the same lane 4.

In practice it has been found that the assembly 1 and the method 100 according to the disclosure fully achieve the set aim and objects, in that the first cascade flow D of liquid C is capable of intercepting, in addition to the products A in transit, also any debris present, carrying (only) such debris downward and removing it from the mass of products A in transit, therefore ensuring an optimal removal thereof.

Evidently, the cascade flows D, F intercept products A of dimensions that do not permit them to fall by gravity through the gap 3 and therefore the flow of liquid C that strikes them cannot make them fall either, nor can it produce any other negative effects on them, and therefore they can continue on their way downstream undisturbed (as desired). Therefore, the assembly 1 and the method 100 according to the disclosure execute an optimal removal of the debris without penalizing the pre-calibration of the products A and without damaging the products A.

The disclosure thus conceived is susceptible of numerous modifications and variations, all of which are within the scope of the appended claims. Moreover, all the details may be substituted by other, technically equivalent ones.

In the embodiments illustrated, individual characteristics shown in relation to specific examples may in reality be substituted with other, different characteristics, existing in other embodiments.

In practice, the materials employed, as well as the dimensions, may be any according to requirements and to the state of the art.

1-9. (canceled)

10. An assembly for processing fruit and vegetable products, which comprises at least two elongated elements for support, arranged mutually side by side and separated by a gap, so as to define a lane for the advancement of fruit and vegetable products, which can move along said lane while resting on said elongated elements above said gap, said assembly comprising dispensing means for at least one liquid, which are configured to form at least one first cascade flow of the liquid, directed toward a predefined segment of said lane, for intercepting the fruit and vegetable products and any debris in transit, wherein said means comprise:
at least one first discharge opening, which substantially surmounts said elongated elements and is configured for dispensing the liquid with formation of the first cascade flow,
at least one tub, which can be fed with the liquid and is located above said at least one lane, said tub being provided with at least one said first discharge opening.

11. The assembly according to claim 10, wherein said dispensing means are configured to form the first cascade flow and a second cascade flow of liquid directed toward the same said lane, for the further interception of the fruit and vegetable products and any debris in transit, said dispensing means comprising at least one second discharge opening, which substantially surmounts said elongated elements and is configured for dispensing the liquid with formation of the second cascade flow.

12. The assembly according to claim 11, wherein said dispensing means are configured to form a first cascade flow and a second cascade flow which are oriented along an advancement direction of the fruit and vegetable products, imposed by said lane, and preferably in opposite directions.

13. The assembly according to claim 11, wherein said at least one discharge opening comprises a chute directed toward said lane.

14. The assembly according to claim 10, further comprising a plurality of said elongated elements, which are mutually side by side and separated by respective said gaps, for defining said corresponding advancement lanes, substantially parallel, for the fruit and vegetable products, said dispensing means being configured to form at least respective first cascade flows of the liquid, which are directed toward corresponding predefined segments of each one of said lanes.

15. The assembly according to claim 14, further comprising:
at least one collection container, configured for a progressive accumulation of debris intercepted by the first cascade flow and removed from said lane, and, optionally,
at least one conveyor belt, located below said predefined segment and leading to said at least one container.

16. The assembly according to claim 14, wherein said tub comprises at least one plurality of said first discharge openings, which are substantially aligned along a first direction which is transverse to said lanes and which surmount respective said predefined segments of corresponding said lanes.

17. The assembly according to claim 10, wherein said dispensing means comprise at least one pump placed in communication with a circuit that can be passed through by the liquid.

18. A method for processing fruit and vegetable products, executed by means of an assembly according to claim 10, further comprising the following steps:
a. moving, along an advancement lane, a plurality of fruit and vegetable products, which are arranged so as to rest on two elongated elements arranged side by side and above a gap for separating the two elongated elements,
b. intercepting the fruit and vegetable products, and any debris, with at least one first cascade flow of liquid, at the point of transit of said fruit and vegetable products and any debris through a predefined segment of the lane.
